(19) United States
(12) Patent Application Publication
(10) Pub. No.: US 2010/0285844 A1
(43) Pub. Date: Nov. 11, 2010

(54) CELLULAR PHONE AND DISPLAY ORIENTATION CONTROL PROGRAM OF CELLULAR PHONE

(75) Inventors: Ayako HOSOI, Tokyo (JP); Akemi TOYOKURA, Tokyo (JP); Satoshi MACHIDA, Tokyo (JP); Yukio KAGAMI, Tokyo (JP); Mitsuhiro SATOU, Tokyo (JP)

Correspondence Address: HOLTZ, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/699,299

(22) Filed: Feb. 3, 2010

(30) Foreign Application Priority Data
May 7, 2009 (JP) P2009-112966

(51) Int. Cl. H04W 88/02

(52) U.S. Cl. 455/566

(57) ABSTRACT

A cellular phone includes: a user interface for accepting an input; a communication interface for making a call via a radio communication with a base station; a display unit for displaying figures and characters; a first display controller for setting a display orientation of the display unit in one of a first display orientation and a second display orientation; and a second display controller for controlling the display unit so that the display orientation is set in the first display orientation if the communication interface starts a call. The first display orientation means a orientation that connects a top sideline of the display unit and a bottom sideline of the display unit, and the second display orientation means a orientation that is obtained by rotating the first display orientation by about 90° clockwise or counterclockwise about a vertical axis of the display unit.

### CROSS-REFERENCE TO RELATED APPLICATIONS

The present disclosure relates to the subject matters contained in Japanese Patent Application No. 2009-112966 filed on May 7, 2009, which are incorporated herein by reference in its entirety.

### BACKGROUND

1. Field of the Invention

One aspect of the present invention relates to a cellular phone which has a function of switching between plural input screens and, in particular, receives an input through a touchscreen, as well as to a display orientation control program of such a cellular phone.

2. Description of Related Art

In recent years, with advancements in a performance of a display function of cellular phones, cellular phones have been put into practical use which can change a display orientation of a display unit. Various kinds of information such as an e-mail, a content on the Internet, a TV moving image, and information relating to an ongoing call are displayed on the display unit. To display each of such various display subjects in an easy-to-see orientation, there are configurations including a function of rotating a display subject on the display unit and a button for switching the display orientation (refer to Japanese Patent Application Publication No. JP-A-2004-72754, for example).

Cellular phones provided with an accelerometer which outputs an inclination detection signal can recognize an inclination of the cellular phone with respect to the ground. There are configurations which employ an accelerometer and set the display orientation to a portrait mode when the cellular phone is held upright with respect to the ground and set the display orientation to a landscape mode also when the cellular phone is held sideways with respect to the ground (refer to Japanese Patent Application Publication No. JP-A-2008-131616, for example). The display orientation of the display unit can be set in an orientation that facilitates viewing of the user by rotating a display subject according to an angle that the cellular phone forms with the ground.

Consideration will be given below to a case that a call is made using a cellular phone as described above which can change the display orientation according to an angle that the cellular phone forms with the ground. In such a cellular phone, usually, a speaker which outputs a voice of a conversation partner is provided at a top portion of a body of the cellular phone and a microphone for picking up a voice of the user is provided at a bottom portion of the body. Therefore, the user holds the cellular phone upright to set the speaker and the microphone close to his or her ear and mouth, respectively. However, when the angle of the cellular phone with respect to the ground is changed because, for example, the user lies down while making a call, the display orientation may be changed so as to be sideways as viewed from the user. Since the orientation of the cellular phone itself does not coincide with the display orientation for the user, the user has difficulty visually recognizing pieces of information displayed on the display unit during the call such as the conversation partner, a call duration, and time information.

### SUMMARY

Illustrative aspects of the present invention provide a cellular phone capable of switching a display orientation according to whether a call is being made or not, and a display orientation control program of the cellular phone.

According to an aspect of the invention, a cellular phone includes: a user interface configured to accept an input; a communication interface configured to make a call via a radio communication with a base station; a display unit configured to display figures and characters; a first display controller configured to set a display orientation of the display unit in one of a first display orientation and a second display orientation; and a second display controller configured to control the display unit so that the display orientation of the display unit is set in the first display orientation if the communication interface starts a call.

### BRIEF DESCRIPTION OF THE DRAWINGS

An exemplary embodiment of the present invention may be described in detail with reference to the accompanying drawings, in which:

FIGS. 1A and 1B show an exemplary appearance of a cellular phone according to an exemplary embodiment;

FIG. 2 is an exemplary block diagram showing an internal configuration of the cellular phone according to the exemplary embodiment;

FIGS. 3A and 3B are exemplary diagrams showing screen displays on a display unit that are employed in the exemplary embodiment as the orientation of the cellular phone is changed in a calling state;

FIGS. 4A and 4B are exemplary diagrams showing screen displays on the display unit that are employed in the exemplary embodiment as an orientation of the cellular phone is changed in a state that the cellular phone is making a call with a headset connected to the cellular phone;

FIG. 5 is an exemplary flowchart of a process according to the exemplary embodiment for controlling the display orientation of the display unit when the cellular phone makes a call with the headset connected to the cellular phone;

FIGS. 6A and 6B are exemplary diagrams showing screen displays on the display unit in which displayed operation buttons are disabled and a small, second call ending button is displayed, and FIGS. 6C and 6D are exemplary diagrams showing screen displays on the display unit in which displayed operation buttons are not disabled and a second call ending button is displayed; and

FIGS. 7A and 7B are exemplary diagrams showing screen displays on the display unit that are employed in the exemplary embodiment as the orientation of the cellular phone is changed in inputting a text.

### DETAILED DESCRIPTION

An exemplary embodiment of the present invention will be hereinafter described with reference to the drawings.

### Configuration of Cellular Phone

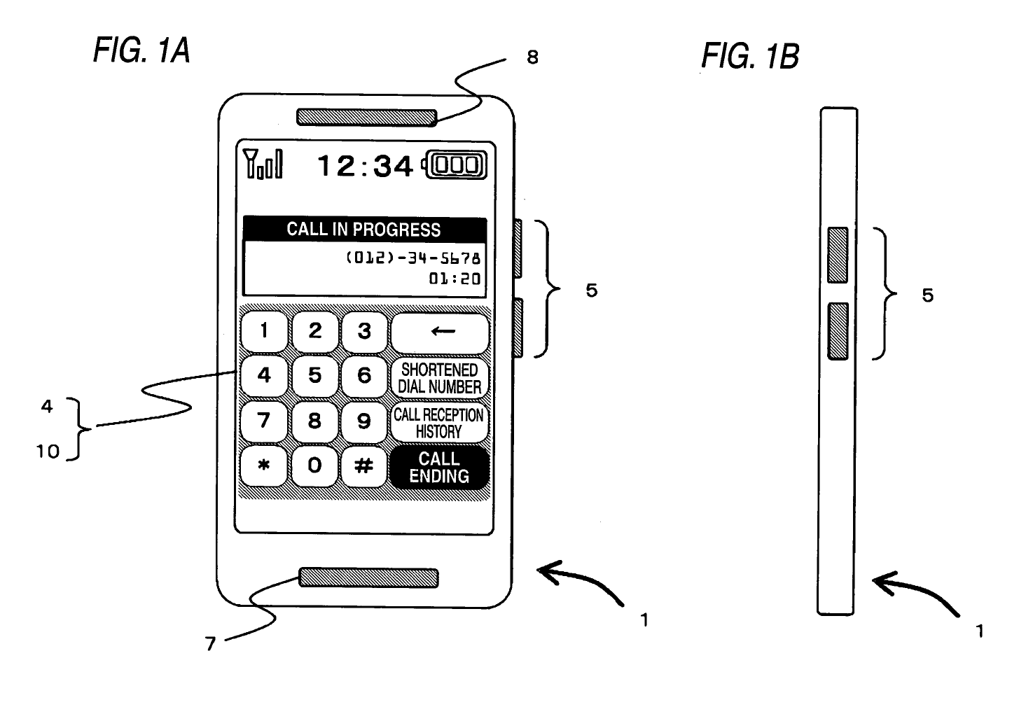

FIG. 1A shows an exemplary appearance of a cellular phone 1 as viewed from the front side and FIG. 1B an exemplary appearance of the cellular phone 1 as viewed from the right side.

As shown in FIG. 1A, a front face of the cellular phone 1 is provided with a display (display unit) 10 which displays characters and figures. A touchscreen 4 is laid on the display 10, and the user makes an input by touching the touchscreen 4. The touchscreen 4 can employ a known input method such as a pressure sensing method or an electrostatic method. In the case of the pressure sensing type, for example, conductive thin films are provided into the display unit 10 so as to have a slight gap. When the front-side thin film is pressed by a finger, a touch pen, or the like, the two thin films come into contact with each other and current flows there. A controller 31 (described later) is informed of coordinates of the current-flow position and performs processing corresponding to the received coordinates (hereinafter referred to as input coordinates).

As shown in FIG. 1B, the right-hand side of the cellular phone 1 is provided with side keys 5. The side keys 5 are assigned such roles as causing a transition to the manner mode and calling a menu. When a side key 5 is pressed, it is detected and the controller 31 is informed of the detection. The user can make an operation by pressing a side key 5 instead of the touchscreen 4.

Accelerometers 12 for detecting a direction of a gravity acceleration acting on the cellular phone 1 are disposed at a prescribed position inside the cellular phone 1 and detect, for example, an angle of the cellular phone 1 with respect to the ground. Any of various known methods can be used as a method for detecting a direction of the gravity acceleration, such as a method of detecting a change in the position of a diaphragm supported by a piezo resistor, a method of detecting a capacitance change, and a method of detecting a change in the quantity of reflection light that depends on the inclination.

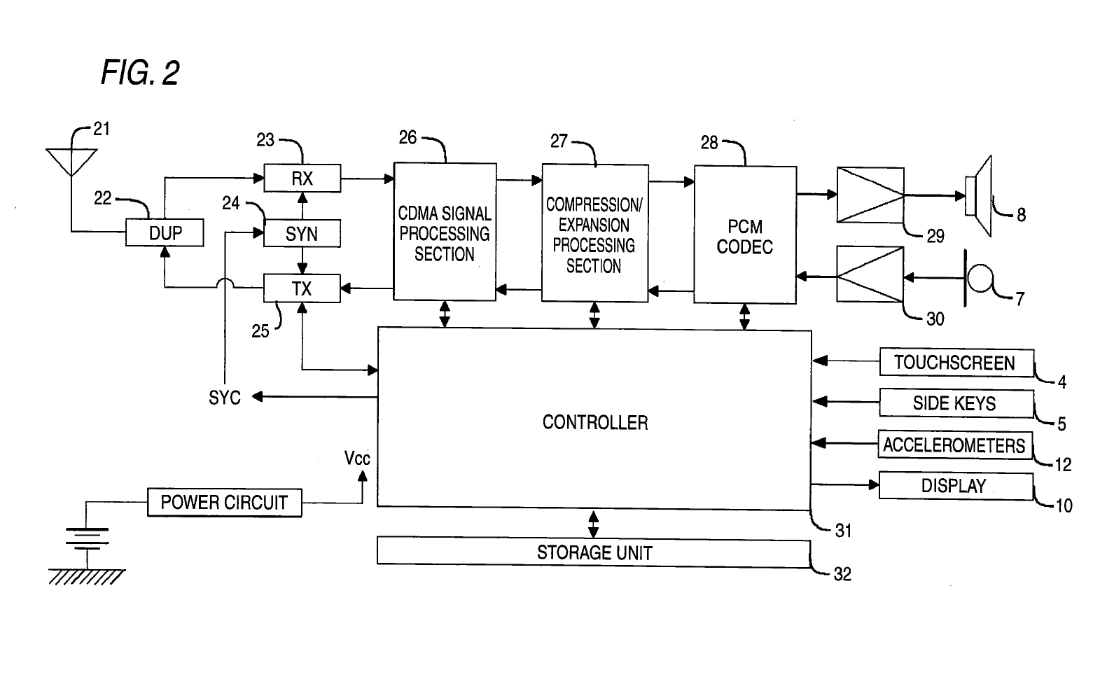

FIG. 2 is an exemplary block diagram showing the internal configuration of the cellular phone 1 according to the exemplary embodiment.

A radio-frequency signal transmitted from a radio base station is received by an antenna 21 and input to a receiving circuit (RX) 23 via an antenna duplexer (DUP) 22. The receiving circuit 23 mixes the received radio-frequency signal with a local oscillation signal that is output from a frequency synthesizer (SYN) 24, and thereby down-converts the radio-frequency signal into an intermediate frequency signal. The intermediate frequency signal is demodulated by the receiving circuit 23 into a reception baseband signal.

The reception baseband signal which is output from the receiving circuit 23 is input to a code division multiple access (CDMA) signal processing section 26, which is provided with a Rake receiver (not shown). In the Rake receiver, each of signals of plural paths included in the reception baseband signal is inverse-spread using its spreading code (i.e., the same spreading code as the spreading code of the spread reception signal). Inverse-spread signals of the respective paths are subjected to phase rotation and coherent Rake combining. A Rake-combined data series is subjected to deinterleaving and channel decoding (error-correction decoding) and then to binary data judgment. In this manner, the CDMA signal processing section 26 generates reception packet data having a prescribed transmission format. The reception packet data is input from the CDMA signal processing section 26 to a compression/expansion processing section 27. A digital signal processor (DSP) acts as the CDMA signal processing section 26.

The compression/expansion processing section 27 separates the reception packet data into signals of respective media such as an audio signal and a data signal by module of a multiplexing/demultiplexing section (not shown). The signals of the respective media are subjected to decoding processing individually in response to the respective media.

On the other hand, an audio signal of the user that is input through a microphone 7 is amplified to a proper level by a transmitter amplifier 30 and converted into pulse code modulation (PCM) codes by a PCM codec 28. The PCM-coded digital audio signal is input to the compression/expansion section 27. A data signal of, for example, a mail and other signals generated by the controller 31 are also input to the compression/expansion section 27. The compression/expansion section 27 compression-codes the digital audio signal that is output from the PCM codec 28 or the data signal that is output from the controller 31 so as to have a format that is suitable for a prescribed transmission data rate. A resulting, compression-coded signal is multiplexed so as to have a prescribed format by the multiplexing/demultiplexing section (not shown) and then packetized. Resulting transmission packet data is input to the CDMA signal processing section 26. The CDMA signal processing section 26 performs spectrum spreading processing on the received transmission packet data and thereby generates a spread signal. The spectrum spreading processing is performed by using a spreading code that is assigned to the transmission channel. The spread signal generated by the CDMA signal processing section 26 is input to a transmitting circuit (TX) 25. The transmitting circuit 25 modulates the spread signal according to a digital modulation method such as quadrature phase shift keying (QPSK) method. Furthermore, the transmitting circuit 25 combines the spread signal with a local oscillation signal generated by the frequency synthesizer 24 and thereby up-converts the combined signals into a radio-frequency signal. The transmitting circuit 25 amplifies the up-converted radio-frequency signal so that it will satisfy a transmission power level that is specified by the controller 31. The amplified radio-frequency signal is supplied to the antenna 21 via the antenna duplexer 22 and transmitted from the antenna 21 toward the radio base station.

The cellular phone 1 is provided with the controller 31. The controller 31 is composed of electronic circuits such as a central processing unit (CPU). The CPU operates according to various application programs loaded in a read-only memory (ROM; described later) or a random access memory (RAM; described later). Furthermore, the CPU processes signals supplied from the above-described individual circuit sections and generates various control signals and supplies them to the individual circuit sections. Operating in the above-described manner, the CPU supervises the cellular phone 1. Still further, when informed of input coordinates of the touchscreen 4, the CPU determines whether the input coordinates coincide with coordinates of an operation button displayed on the display 10. If coincidence is found, the CPU performs processing that is assigned to the operation button, such as a menu operation, character input, call origination, or incoming call acceptance.

For example, a storage unit 32 is composed of the ROM, the RAM, a flash memory which is an electrically rewritable and erasable nonvolatile memory, a hard disk drive (HDD), etc. Various application programs to be run by the CPU of the controller 31 and related data groups are stored in the storage unit 32. Data that are necessary for the CPU to perform various kinds of processing and information relating to an image to be displayed on the display 10 are stored in the RAM.

### Display Orientation Changing Process

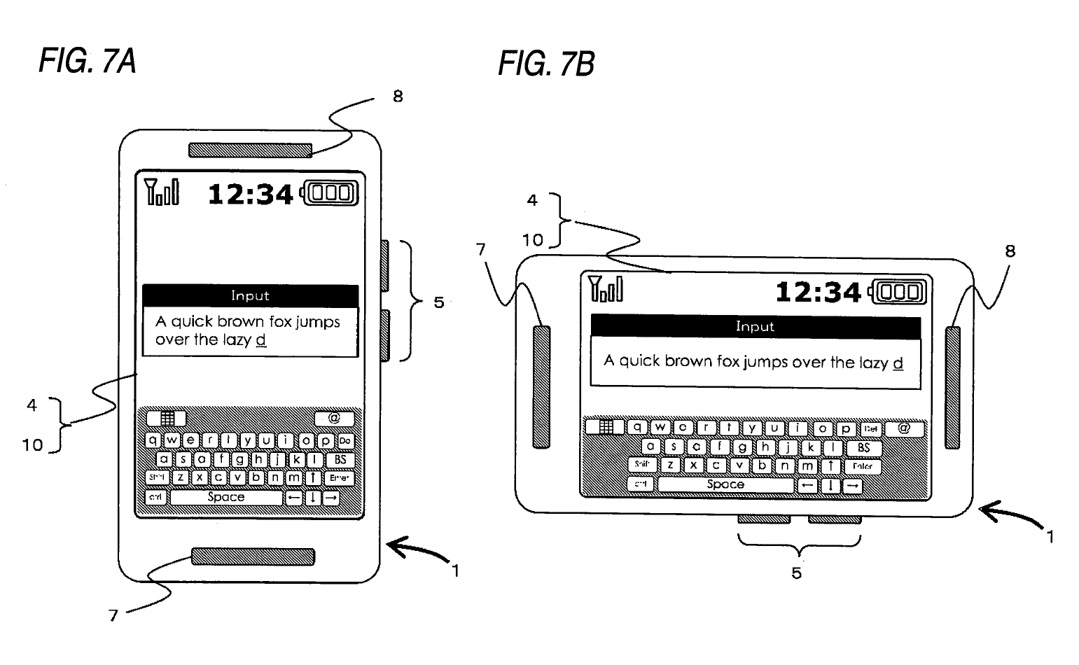

FIG. 7A shows an example screen display on the display 10 that is displayed in the portrait mode when the cellular phone 1 is oriented upright with respect to the ground. FIG. 7B shows an example screen display on the display 10 that is displayed in the landscape mode when the cellular phone 1 is oriented sideways with respect to the ground. Although the example screen displays of FIGS. 7A and 7B are for text input, display orientation changing processing is performed for various screen displays such as an e-mail text, a content on the Internet, a TV moving image, and a setting screen of the cellular phone 1.

As shown in FIGS. 7A and 7B, the screen display orientation of the display 10 is changed according to the orientation in which the user holds the cellular phone 1. One method for recognizing a orientation of the cellular phone 1 is to use the accelerometers 12. An inclination of the cellular phone 1 with respect to the ground is detected by providing accelerometers 12 along two or three axes.

For example, the screen display orientation of the display 10 is controlled in the following manner. When the inclination of the cellular phone 1 with respect to the ground is changed, the accelerometers 12 detect the inclination change and output resulting inclination detection signals to the controller 31. Receiving the inclination detection signals, the controller 31 compares the current display orientation of the display 10 with the orientation of the cellular phone 1 with respect to the ground. If the current display orientation of the display 10 is not suitable for the inclination angle of the cellular phone 1 with respect to the ground that is recognized by the controller 31 based on the inclination detection signals, the controller 31 outputs, to the display 10, a screen display control signal for changing the display orientation. The display 10 receives the screen display control signal and changes the display orientation.

Another method for recognizing an orientation of the cellular phone 1, such as a method using a gyro sensor or a method using a geomagnetism sensor, may be employed as appropriate.

If the shape of the display 10 is not 90° rotation-symmetrical, for example, it is in rectangle shape, the display 10 is seen differently by the user when the display 10 is orientated upright than when the display 10 is oriented sideways. In view of this, when the orientation of the cellular phone 1 is changed from upright to sideways with respect to the ground as shown in FIGS. 7A and 7B, the aspect ratio or the display position of each of display elements such as a text display area and a keyboard is changed. Furthermore, each display element is rotated (i.e., the display orientation is changed).

In this manner, the display orientation of the display 10 is changed according to the inclination of the cellular phone 1 with respect to the ground. Therefore, even if the orientation in which the user holds the cellular phone 1 is changed, display subjects of the display 10 can be displayed in the portrait mode.

For example, to input a text or read an e-mail using the cellular phone 1 shown in FIG. 1 which has the rectangular display 10, the user may incline the cellular phone 1 so that its longer sideline comes to be located parallel with the ground. As the inclination of the cellular phone 1 is varied, the controller 31 receives inclination detection signals that are output from the accelerometers 12 and changes the display orientation of the display 10 so that the display orientation becomes parallel with the shorter axis of the cellular phone 1. Since the display orientation of the display 10 is changed so as to be parallel with the shorter axis of the cellular phone 1, the number of characters that can be displayed on one line of the display 10 is increased and hence the legibility to the user is enhanced. On the other hand, to display an ordinary use screen, a menu screen, or the like of the cellular phone 1, the user inclines the cellular phone 1 so that its shorter sideline comes to be located parallel with the ground. As the inclination of the cellular phone 1 is varied, the controller receives inclination detection signals that are output from the accelerometers 12 and changes the display orientation of the display 10 so that the display orientation becomes parallel with the longer axis of the cellular phone 1. Since the display orientation of the display 10 is changed so as to be parallel with the longer axis of the cellular phone 1, the user can operate the cellular phone 1 while holding the cellular phone 1 in the upright orientation in which the user can hold it more easily. The ease of operation to the user is thus enhanced. As described above, by inclining the cellular phone 1 to an easy-to-see or easy-to-operate orientation according to processing that the cellular phone 1 is to perform, the user can use the cellular phone 1 with a display orientation that is preferable to the user.

The above example is such that the display orientation of the display 10 is changed automatically based on inclination detection signals that are output from the accelerometers 12. However, the display orientation of the display 10 need not always be changed automatically. For example, a configuration is possible in which a display orientation changing button for changing the display orientation of the display 10 is provided and the display orientation of the display 10 is changed when the display orientation changing button is operated. In a cellular phone which has plural bodies, and in which one, provided with a display unit, of the bodies is rotated or in which one of plural bodies is slidable, the display orientation of the display unit may be changed with a movement of the body as a trigger.

### Call Screen Display Process

The operation for changing the display orientation of the display 10 when the cellular phone 1 is inclined has been described above. Where the accelerometers 12, for example, are used, the user can use the cellular phone 1 with a preferable display orientation by inclining the cellular phone 1. Consideration will now be given to a case of making a call using the cellular phone 1. As shown in FIG. 1, in the cellular phone 1, the speaker 8 is disposed over the display 10 and the microphone 7 is disposed under the display 10. While making a call, the user sets the speaker 8 and the microphone close 7 to his or her ear and mouth, respectively, and hence the cellular phone 1 is held approximately upright with respect to the user. Therefore, to check information displayed on the display 10 during a call, it is necessary to set the display orientation to a portrait mode irrespective of the inclination or the like of the cellular phone 1. In view of this, in the cellular phone 1 according to the exemplary embodiment, when the user makes a call using the cellular phone 1, the display orientation of the display 10 is set to the portrait mode so as to coincide with the orientation in which the user holds the cellular phone 1.

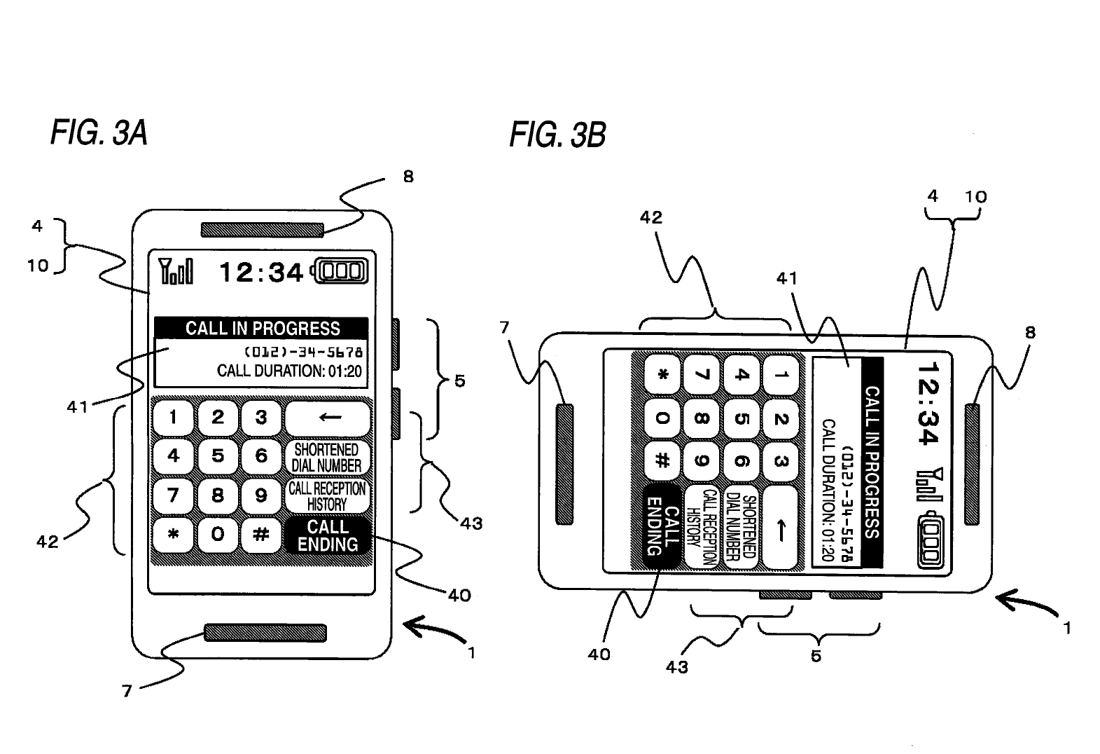

Furthermore, during a call, even if receiving inclination detection signals that are output from the accelerometers 12, the controller 31 does not perform a display orientation control on the display 10 based on the inclination detection signals. Since the controller 31 does not perform the display orientation control, the display orientation of the display 10 is kept in the portrait mode during a call. FIGS. 3A and 3B show example screen displays on the display 10 that are employed in the exemplary embodiment in a state the cellular phone 1 is making a call. An antenna pictograph indicating radio wave reception intensity of the antenna 21, a battery pictograph indicating residual energy of a battery provided inside the cellular phone 1, time information indicating present time, etc. are displayed in a top area of the display 10. An information display window 41 in which to display such information as a character string indicating a call status, a call destination telephone number, and a call duration is displayed at a center area of the display 10. For example, numeral buttons 42 for dialing, control buttons 43 for such operations as deletion of an input call destination number, dialing using a shortened number, and referring to a history of received calls, and a call ending button 40 for disconnecting a channel being used for a call are displayed in a bottom area of the display 10.

If the cellular phone 1 starts a call in a state that the cellular phone 1 is oriented upright with respect to the ground (see FIG. 3A), the controller 31 sets the display orientation of the display 10 to the portrait mode. Even if the cellular phone 1 in a calling state is inclined so as to be oriented sideways with respect to the ground (see FIG. 3B), the controller 31 does not perform a control for changing the display orientation of the display 10. As a result, the display orientation of the display 10 is kept in the portrait mode.

During a call, the display orientation of the display 10 is controlled in, for example, the following manner. First, if detecting that a call has been started, the controller 31 outputs, to the display 10, a display control signal for setting the display orientation to the portrait mode.

While the call is continued, the controller 31 does not output a display control signal for changing the display orientation of the display 10 even if receiving inclination detection signals that are output from the accelerometers 12. After detecting that the call has finished, if inclination detection signals are received from the accelerometers 12 and the display orientation of the display 10 is not suitable for the orientation of the cellular phone 1 with respect to the ground, the controller 31 outputs a display control signal for changing the display orientation based on the inclination detection signals.

In the exemplary embodiment, if the cellular phone 1 in a calling state is oriented sideways with respect to the ground and the controller 31 receives inclination detection signals from the accelerometers 12, the display orientation that is set to the portrait mode is maintained by the controller 31′s refraining from outputting a display control signal. However, the same advantage can be obtained by setting the display orientation of the display 10 to the portrait mode in starting a call and disabling the inclination detecting operation of the accelerometers 12 or stopping output of inclination detection signals from the accelerometers 12 during the call.

According to the above process, when the cellular phone 1 starts a call, the controller 31 sets the display orientation of the display 10 to the portrait mode so that the display orientation coincides with the orientation in which the user holds the cellular phone 1. Even if receiving inclination detection signals from the accelerometers 12, the controller 31 does not output a display control signal. This allows the user to make a call with the display orientation of the display 10 kept to the portrait mode irrespective of the orientation of the cellular phone 1 with respect to the ground.

As shown in FIG. 3A, the call ending button 40 is displayed on the display 10. According to the exemplary embodiment, even if the cellular phone 1 is inclined so as to be sideways with respect to the ground as shown in FIG. 3B, the position of the call ending button 40 is not moved. This prevents an event that when the cellular phone 1 is inclined, a call ending operation is made unintentionally because the position of the call ending button 40 is moved due to a change of the display orientation and touched by the head (cheek) of the user.

In the exemplary embodiment, the display orientation of the display 10 is controlled so as to set to the portrait mode with a start of call processing as a trigger. Alternatively, for example, the display orientation may be controlled in the same manner with a call start operation by the user as a trigger. As a further alternative, the display orientation may be controlled in the same manner with incoming call acceptance as a trigger.

### Display Orientation Changing Process in A State That A Headset is Connected

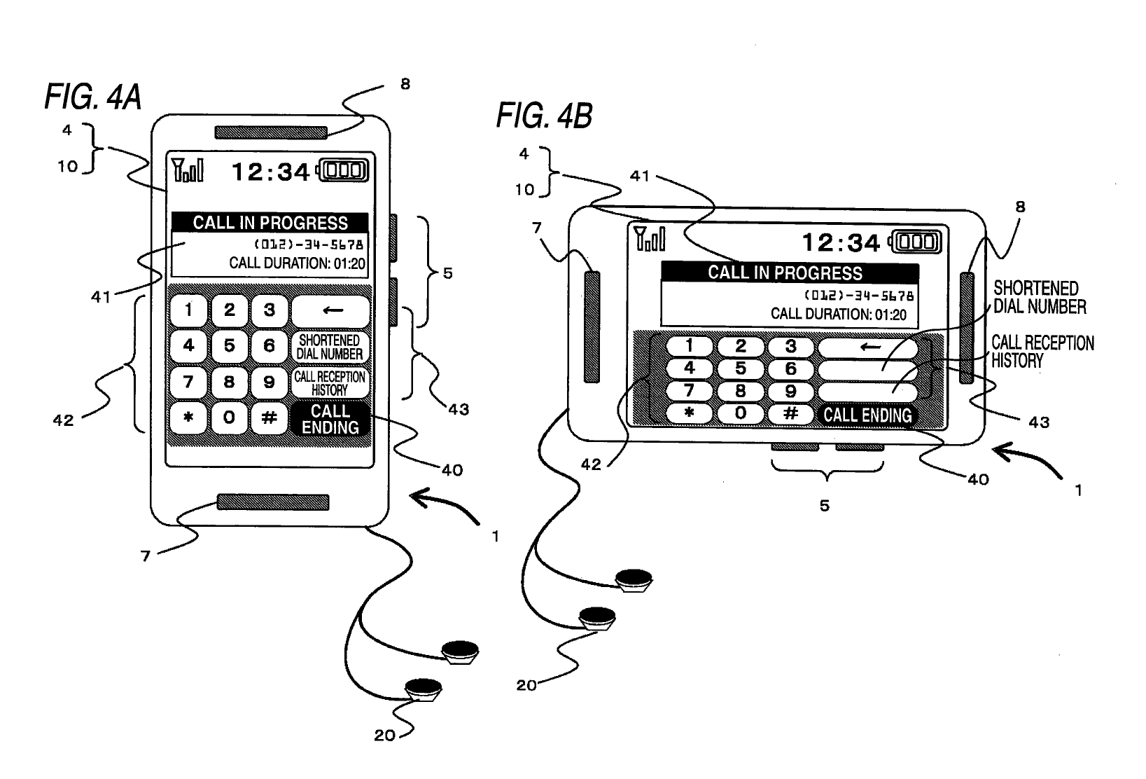

In recent years, as shown in FIGS. 4A and 4B, a technique has been put into practical use that enables a call using an earphone and a microphone that are connected to a cellular phone 1 instead of the speaker 8 and the microphone 7 that are incorporated in the cellular phone 1. In general, a set of an earphone and a microphone to be connected to a cellular phone 1 is called a headset 20. By using the headset 20, the user can make a call without holding the cellular phone 1.

Where the user makes a call by connecting such the headset 20 to the cellular phone 1, the user need not bring his or her ear and mouth close to the speaker 8 and the microphone 7, respectively and hence can hold the cellular phone 1 in an orientation in which the user can hold the cellular phone 1 more easily at that time. Therefore, when the user makes a call by connecting the headset 20 to the cellular phone 1, it is desirable that the display orientation of the display 10 be changed according to the orientation of the cellular phone 1. FIGS. 4A and 4B show example screen displays on the display 10 that are employed in a state the cellular phone 1 is making a call with the headset 20 connected to the cellular phone 1.

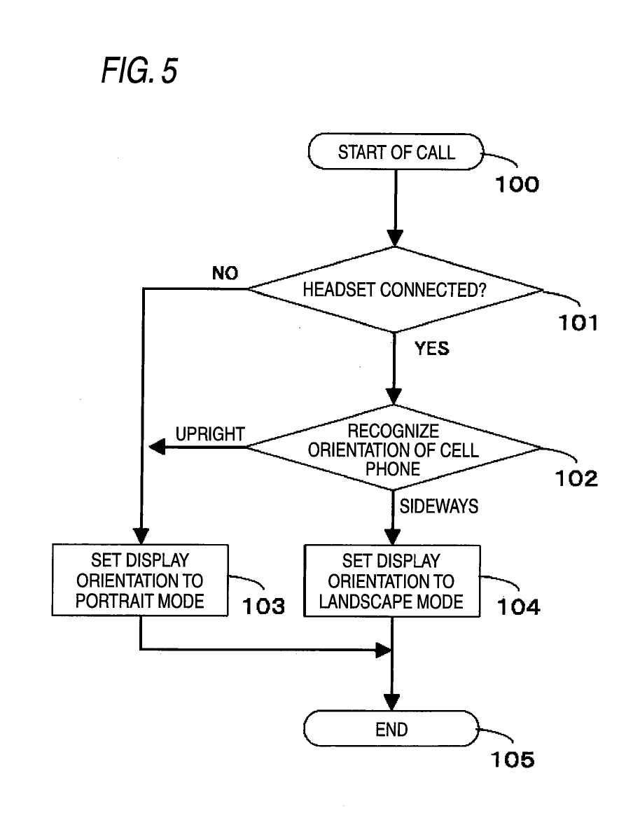

A control process of the screen display orientation which is executed when the cellular phone 1 makes a call with the headset 20 connected to the cellular phone 1 will be described below. FIG. 5 is an exemplary flowchart of the control process of the screen display orientation. First, if detecting a start of a call at step 100, the controller 31 determines at step 101 whether or not the headset 20 is connected to the cellular phone 1. If the headset 20 is not connected to the cellular phone 1 (step 101: no), the controller 31 outputs at the step 103, to the display 10, a display control signal for setting the display orientation to the portrait mode. Then, the process is finished at step 105. On the other hand, if the headset 20 is connected to the cellular phone 1 (step 101: yes), at step 102 the controller 31 detects orientation of the cellular phone 1 with respect to the ground based on inclination detection signals that are output from the accelerometer 12. If the cellular phone 1 is oriented upright with respect to the ground (step 102: upright), at step 103 the controller 31 outputs, to the display 10, a display control signal for setting the display orientation to the portrait mode. Then, the process is finished at step 105. On the other hand, if the cellular phone 1 is oriented sideways with respect to the ground (step 102: sideways), at step 104 the controller 31 outputs, to the display 10, a display control signal for setting the display orientation to a landscape mode. Then, the process is finished at step 105.

In the above process, when the cellular phone 1 to which the headset 20 is connected has started a call and is oriented sideways with respect to the ground, the controller 31 controls the display orientation of the display 10 so as to set the display orientation to the landscape mode. As a result, the display 10 can display an image in such an orientation that the user can visually recognize the image more easily.

Where the headset 20 is not connected to the cellular phone 1, as described above, the controller 31 controls the display orientation of the display 10 so as to set the display orientation to the portrait mode irrespective of the orientation of the cellular phone 1 when a call has been stated.

On the other hand, where the headset 20 is connected to the cellular phone 1, it is desirable that the display orientation be changed as appropriate according to a change in the orientation of the cellular phone 1 with respect to the ground. Therefore, when a call is made in a state that the headset 20 is connected to the cellular phone 1, the controller 31 detects orientation of the cellular phone 1 with respect to the ground based on inclination detection signals that are output from the accelerometers 12. If the display orientation is not suitable for the orientation of the cellular phone 1, the controller 31 outputs a display orientation control signal to the display 10 and thereby changes the display orientation of the display 10.

In the exemplary embodiment, it was stated that the headset 20 is a set of a speaker and a microphone. However, the headset 20 may have only a microphone or a speaker. The headset 20 may be such as to be connected to the cellular phone 1 by radio connection. Furthermore, the same display orientation control process as described above may be executed when an external device other than the headset 20, such as a camera or a display device, is connected to the cellular phone 1.

The same process as executed when the headset 20 is connected to the cellular phone 1 may be executed when the user makes a video telephone call using the cellular phone 1 in such a manner that it is distant from the head of the user.

### Display of Call Ending Button

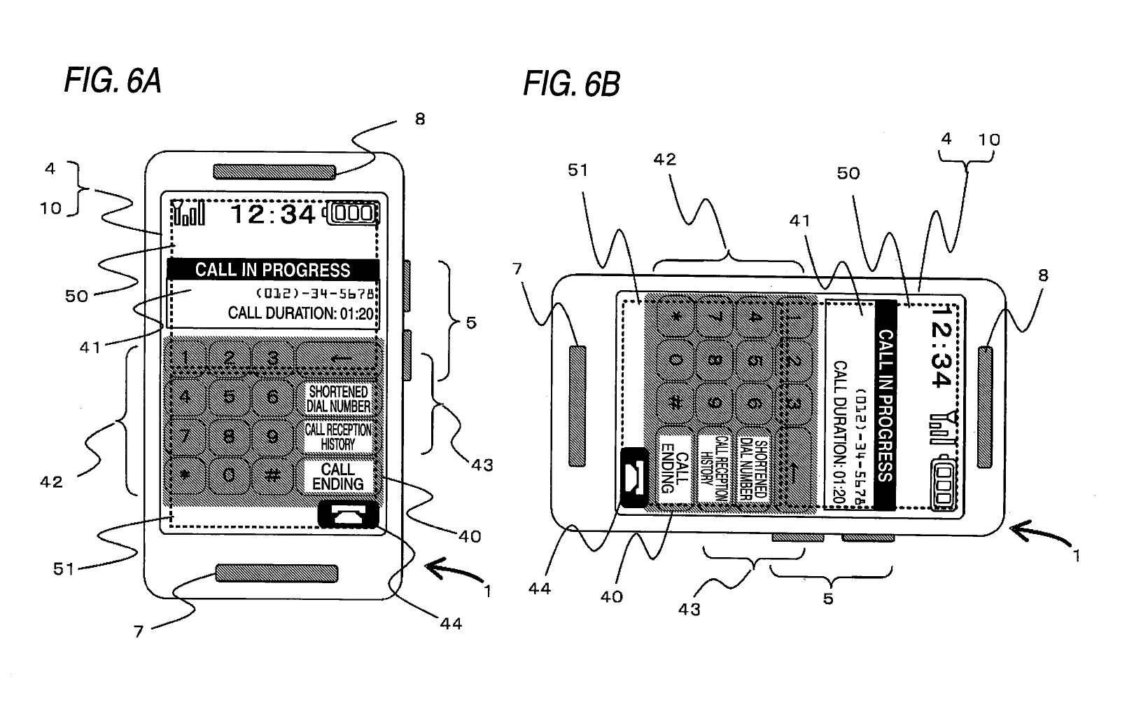

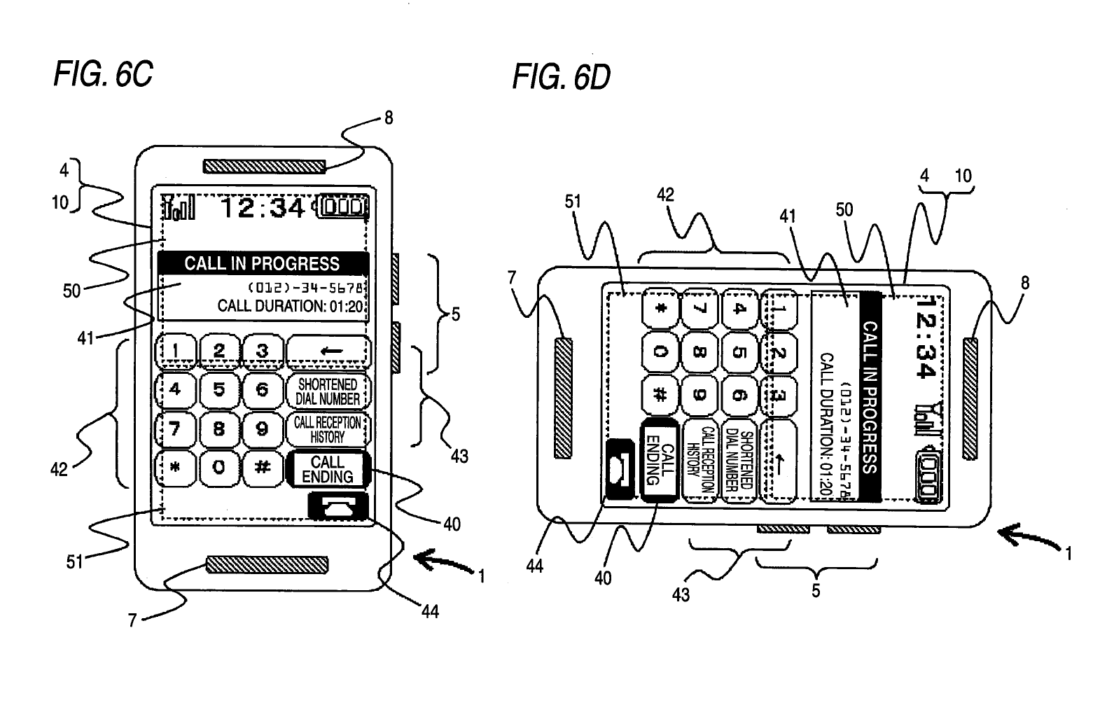

During a call, the user sets his or her ear and mouth close to the speaker 8 and the microphone 7, respectively, and hence an erroneous operation may be caused by an event that the head (cheek) of the user touches an operation button. In view of this, during a call, it is desirable that the operation buttons displayed on the display 10 be disabled so that no input is made through those buttons. FIGS. 6A and 6B show example screen displays on the display 10 in a case that the operation buttons displayed thereon are disabled while the cellular phone 1 is in a calling state. As shown in FIGS. 6A and 6B, when a call has been started, the numeral buttons 42 and the control buttons 43 are disabled so as not to accept an input. Furthermore, a second call ending button 44 which is smaller than each control button 43 is displayed at a bottom position of the screen of the display 10, for example, at a position that is close to the microphone 7. The second call ending button 44 may be smaller than some other operation buttons.

Usually, while the user makes a call using the cellular phone 1, his or her head (cheek) touches the screen at its portion that is close to the speaker 8. On the other hand, the portion of the screen that is close to the microphone 7 is relatively distant from the head (cheek). Displaying the second call ending button 44 at the position close to the microphone 7 and disabling the other operation buttons make it possible to prevent an erroneous operation even if the posture of the user is changed during a call. Displaying the second call ending button 44 in small size makes it possible to prevent an event that the second call ending button 44 is operated if the head (cheek), for example, of the user touches the screen of the display 10 unintentionally.

The display position of the second call ending button 44 is not limited to the position shown in FIGS. 6A and 6B; the second call ending button 44 may be displayed at any of various positions. For example, the second call ending button 44 may be displayed at the center of an edge portion of the screen of the display 10 that is adjacent to the microphone 7. As a further alternative, the second call ending button 44 may be displayed at any position in a microphone-side area 51 in the case where the screen of the display 10 is equally divided into a speaker-side area 50 and the microphone-side area 51. The shape and the size of the second call ending button 44 are not limited to the ones shown in FIGS. 6A and 6B. For example, characters such as “Call ending” may be displayed in the button 44 or it may have an elliptical or polygonal shape.

If there is no probability that the user makes an erroneous operation during a call, call processing may be performed without disabling the operation buttons. FIGS. 6C and 6D show example screen displays on the display 10 in which the operation buttons are not disabled and a second call ending button 44 is displayed.

Whether to disable the operation buttons during a call is set by the user in advance and the setting information is stored in the storage unit 32 in advance. For example, if there is no probability that the user makes an erroneous operation during a call, the user stores, in the storage unit 32, setting information to the effect that the operation buttons need not be disabled. Upon starting call processing, the controller 31 reads the setting information from the storage unit 32 and performs the call processing keeping the operation buttons effective if the setting information is such that the operation buttons need not be disabled during a call.

This allows the user to operate the cellular phone 1 using all the operation buttons if there is no probability that the user makes an erroneous operation during a call.

According to the exemplary embodiment, in the cellular phone 1 in which the display orientation of the display 10 is variable, since the display orientation of the display 10 is controlled during a call, an image can be displayed on the display 10 in such an orientation that the user can visually recognize the display 10 more easily.

During a call, the numeral buttons 42 and the control buttons 43 are disabled and the small, second call ending button 44 is displayed at a bottom position of the screen of the display 10. These measures make it possible to prevent an unintended operation even if the user touches the screen of the display 10 inadvertently during a call.

The exemplary embodiment is directed to the case that the cellular phone 1 employs the touchscreen 4 as a user interface. However, instead of using the touchscreen 4, the user interface may be composed of various input devices such as push buttons and a keyboard. Although in the exemplary embodiment the display 10 has a rectangular shape, it may have any of various shapes such as an ellipse and polygons. The layout and the shapes of the call ending button 40, the numeral buttons 42, the control buttons 43, and the information display window 41 are not limited to the ones shown in the drawings and may be modified in various manners. In short, the invention is not limited to the above exemplary embodiment and may be embodied in such a manner that constituent elements are modified without departing from the spirit and scope of the invention. And various inventions may be conceived by properly combining plural constituent elements disclosed in the exemplary embodiment. For example, several ones of the constituent elements of the exemplary embodiment may be omitted.

What is claimed is:

1. A cellular phone comprising:
a user interface configured to accept an input;
a communication interface configured to make a call via a radio communication with a base station;
a display unit configured to display figures and characters;
a first display controller configured to set a display orientation of the display unit in one of a first display orientation and a second display orientation; and
a second display controller configured to control the display unit so that the display orientation of the display unit is set in the first display orientation if the communication interface starts the call.

2. The cellular phone of claim 1 further comprising:
an earpiece unit provided on one side of the cellular phone; and
a mouthpiece unit provided on a side opposite to the earpiece unit with the display unit interposed in between,
wherein the first display orientation is configured to be a orientation that connects a top sideline of the display unit that is located on the side of the earpiece unit and a bottom sideline of the display unit that is located on the side of the mouthpiece unit, and
wherein the second display orientation is configured to be a orientation that is obtained by rotating the first display orientation by about 90° clockwise or counterclockwise about an axis that is perpendicular to a screen of the display unit.

3. The cellular phone of claim 1, wherein the second display controller is configured to control the display unit so that the display orientation is kept in the first display orientation during the call.

4. The cellular phone of claim 1 further comprising:
an accelerometer configured to detect an inclination of the cellular phone with respect to the ground, and output inclination information,
wherein the first display controller is configured to set the display orientation in one of the first display orientation and the second display orientation based on the inclination information.

5. The cellular phone of claim 4, wherein the second display controller is configured to control the accelerometer to stop outputting the inclination information during the call.

6. The cellular phone of claim 1, wherein the second display controller is configured not to control the display unit if an external device to be used for the call is connected to the cellular phone.

7. The cellular phone of claim 1,
wherein the user interface is configured to comprise:
a first operation portion configured to command ending of the call being performed by the communication interface; and
a second operation portion, and
wherein during the call the second display controller is configured to enable the first operation portion and disable the second operation portion.

8. The cellular phone of claim 2,
wherein the user interface is configured to be a touchscreen which is integrally provided with the display unit and detects input coordinates,
wherein the display unit is configured to have a first area that is located on the side of the earpiece unit and a second area that is opposite to the first area, and
wherein during the call the second display controller is configured to control the display unit so that the display unit displays, in the second area, a operation button for accepting a operation for ending the call.

9. A cellular phone comprising:
a user interface configured to accept an input;
a communication interface configured to make a call via a radio communication with a base station;
a display unit configured to display figures and characters;
a first display controller configured to set a display orientation of the display unit in one of a first display orientation and a second display orientation; and
a second display controller configured to control the display unit so that the display orientation is set in the first display orientation if the user interface accepts an input for starting a call.

10. The cellular phone of claim 9 further comprising:
an earpiece unit provided on one side of the cellular phone;
a mouthpiece unit provided on a side opposite to the earpiece unit with the display unit interposed in between,
wherein the first display orientation is configured to be a orientation that connects a top sideline of the display unit that is located on the side of the earpiece unit and a bottom sideline of the display unit that is located on the side of the mouthpiece unit, and
wherein the second display orientation is configured to be a orientation that is obtained by rotating the first display orientation by about 90° clockwise or counterclockwise about an axis that is perpendicular to a screen of the display unit.

11. The cellular phone of claim 9, wherein the second display controller is configured to control the display unit so that the display orientation is kept in the first display orientation during the call.

12. The cellular phone of claim 9 further comprising:
an accelerometer configured to detect an inclination of the cellular phone with respect to the ground, and output inclination information,
wherein the first display controller is configured to set the display orientation in one of the first display orientation and the second display orientation based on the inclination information.

13. The cellular phone of claim 12, wherein the second display controller is configured to control the accelerometer to stop outputting the inclination information during the call.

14. The cellular phone of claim 9, wherein the second display controller is configured not to control the display unit if an external device to be used for the call is connected to the cellular phone.

15. The cellular phone of claim 9,
wherein the user interface is configured to comprise:
a first operation portion which commands ending of the call being performed by the communication interface; and
a second operation portion, and
wherein during the call the second display controller is configured to enable the first operation portion and disable the second operation portion.

16. The cellular phone of claim 10,
wherein the user interface is configured to be a touchscreen which is integrally provided with the display unit and detects input coordinates,
wherein the display unit is configured to have a first area that is located on the side of the earpiece unit and a second area that is opposite to the first area, and
wherein during the call the second display controller is configured to control the display unit so that the display unit displays, in the second area, a operation button for accepting a operation for ending the call.

17. A computer-readable medium containing a display orientation control program of a cellular phone including a display unit, an earpiece unit, and a mouthpiece unit, for:
performing a first display control function for setting a display orientation of the display unit in one of a first display orientation and a second display orientation;
performing a communication function for making a call via a radio communication with a base station; and
performing a second display control function for controlling the display unit so that the display orientation of the display unit is set in the first display orientation that connects a top sideline of the display unit that is located on the side of the earpiece unit and a bottom sideline of the display unit that is located on the side of the mouthpiece unit if the communication function starts a call.
